(19) United States
(12) Patent Application Publication
(10) Pub. No.: US 2007/0166019 A1
(43) Pub. Date: Jul. 19, 2007

(54) Information processing apparatus

(75) Inventor: Chihei Kitahara, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/641,912

(22) Filed: Dec. 20, 2006

(30) Foreign Application Priority Data
Jan. 19, 2006 (JP) 2006-011510

(51) Int. Cl. G03B 17/00

(52) U.S. Cl. 396/51

(57) ABSTRACT

According to one embodiment, an information processing apparatus includes a main unit having a palm rest portion, a display unit, and an illumination device. The display unit is rotatable between a first state in which the display unit is closed with respect to the main unit, and a second state in which the display unit is opened with respect to the main unit. The illumination device is located opposite the display unit in the second state, with the palm rest portion interposed therebetween.

### CROSS-REFERENCE TO RELATED APPLICATIONS

This application is based upon and claims the benefit of priority from Japanese Patent Application No. 2006-011510, filed Jan. 19, 2006, the entire contents of which are incorporated herein by reference.

### BACKGROUND

1. Field

One embodiment of the invention relates to an information processing apparatus, for example, having an illumination device for decorating the main body thereof.

2. Description of the Related Art

For example, as disclosed in Jpn. Pat. Appln. KOKAI Pub. No. 2002-287671, there are light-emitting devices which display characters and the like inside a vehicle. The light-emitting devices have a light source and a light guide plate. The light guide plate has a plurality of grooves to reflect light from the light source. The grooves guide light to an upper surface of the light guide plate. In this case, the light guide plate has a structure in which the grooves gradually approach the upper surface as they become distant from the light source. Therefore, in the light-emitting device, even a groove distant from the light source guides light having intensity equal to that of a groove close to the light source to the upper surface of the light guide plate. This structure enables display of characters of uniform light intensity on the light guide plate.

On the other hand, there are portable computers which have a main unit including a keyboard, and a display unit including a display. In the portable computers, the display unit can be rotated between a state where the display unit is open to the main unit, and a state where the display unit is closed to the main unit. To improve the appearance of the portable computers, there is a way of providing the light-emitting device converted to illumination, that is, an illumination device, to the portable computers. However, providing the illumination device can be performed in various ways.

Specifically, if the illumination device is simply provided on the upper surface of the display unit, the visual effects of the illumination device may not be produced, since the user cannot view the illumination device while the portable computer is used. Further, if the illumination device is provided in the vicinity of the display unit, light of the illumination device may directly enter the user's eyes, and deteriorate viewability of the display unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary front view of a portable computer according to an embodiment of the present invention, in which a display unit is in a first state.

FIG. 2 is an exemplary perspective view of the portable computer illustrated in FIG. 1, in which the display unit is in a second state.

FIG. 3 is an exemplary enlarged perspective view of a part of the portable computer of FIG. 1 around the illumination device.

FIG. 4 is an exemplary bottom view of a part of a housing of the portable computer illustrated in FIG. 1.

FIG. 5 is an exemplary vertical cross-sectional view of a main unit and the display unit of the portable computer illustrated in FIG. 1, in which the display unit is in the first state.

FIG. 6 is an exemplary cross-sectional view of the portable computer, cut along line F6-F6 shown in FIG. 5.

FIG. 7 is an exemplary perspective view illustrating a state where the portable computer illustrated in FIG. 1 is being used.

FIG. 8 illustrates an example of a state where the display unit illustrated in FIG. 5 is being opened from the first state to the second state.

### DETAILED DESCRIPTION

Various embodiments according to the invention will be described hereinafter with reference to the accompanying drawings. In general, according to one embodiment of the invention, an information processing apparatus includes a main unit having a palm rest portion, a display unit, and an illumination device. The display unit is rotatable between a first state in which the display unit is closed with respect to the main unit, and a second state in which the display unit is opened with respect to the main unit. The illumination device is located opposite the display unit in the second state, with the palm rest portion interposed therebetween.

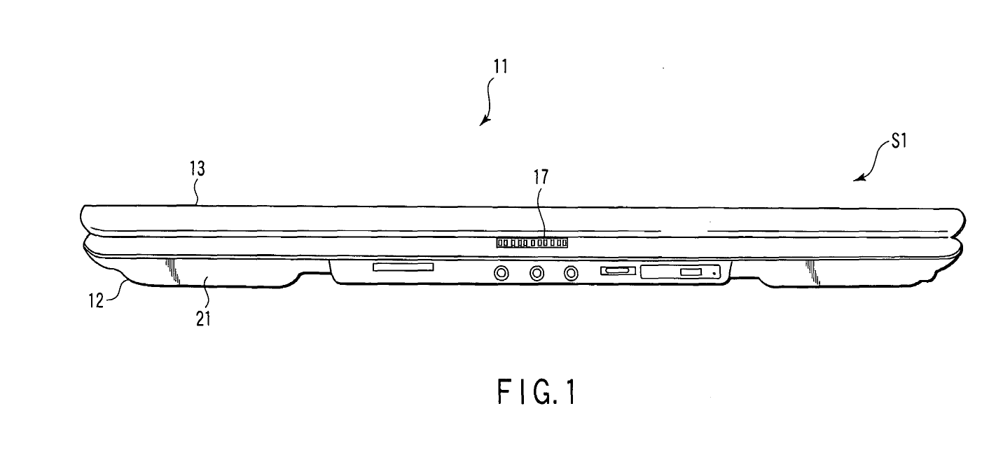

An embodiment of an information processing apparatus according to the present invention will now be described with reference to FIGS. 1 to 8.

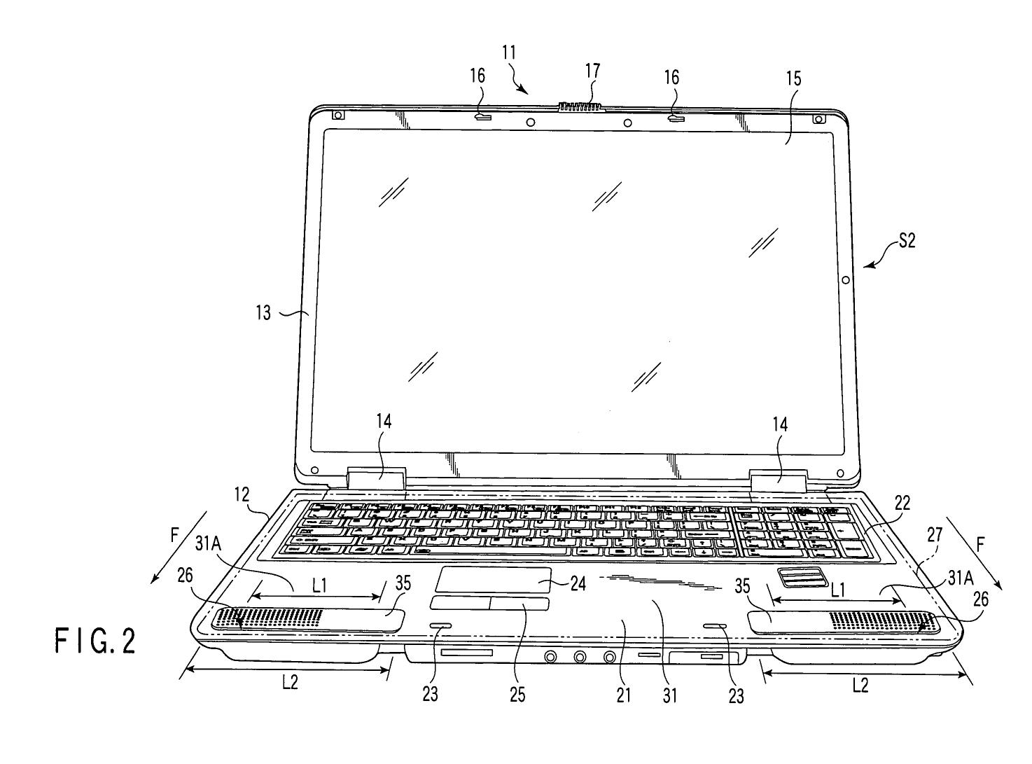

As shown in FIGS. 1 and 2, a portable computer 11 being an example of the information processing apparatus comprises a main unit 12, a display unit 13, and hinge parts 14 which are provided between the main unit 12 and the display unit 13. The hinge parts 14 rotatably support the display unit 13. The hinge portions 14 rotate the display unit 13 between a first state S1 in which the display unit 13 is closed with respect to the main unit 12, and a second state S2 in which the display unit 13 is opened with respect to the main unit 12. The display unit 13 has a display 15, latches 16, and a latch release lever 17.

The main unit 12 has a housing 21, a keyboard 22, receiving portions 23 with which the latches 16 are engaged, a touch pad 24 being a pointing device, and a control button 25. The main unit 12 also has illumination devices 26. The illumination devices 26 are provided in an area 27 on the main unit 12, covered with the display unit 13 in the first state S1. The illumination devices 26 are provided to be opposed to the display unit 13 in the second state S2 with the keyboard 22 interposed therebetween, and closer toward the front in the front direction F.

On the housing 21 of the main unit 12, a palm rest portion 31 is provided in front of the keyboard 22. With respect to the palm rest portion 31, the illumination devices 26 are provided to be opposed to the display unit 13 in the second state S2 with the palm rest portion 31 interposed therebetween. Specifically, the illumination devices 26 are provided closer toward the front in the front direction F than the palm rest portion 31 is. As shown in FIG. 2, the palm rest portion 31 has a pair of regions 31A on which the user's hands are placed. The illumination devices 26 have a width L2 which is wider than a width L1 of the regions 31A.

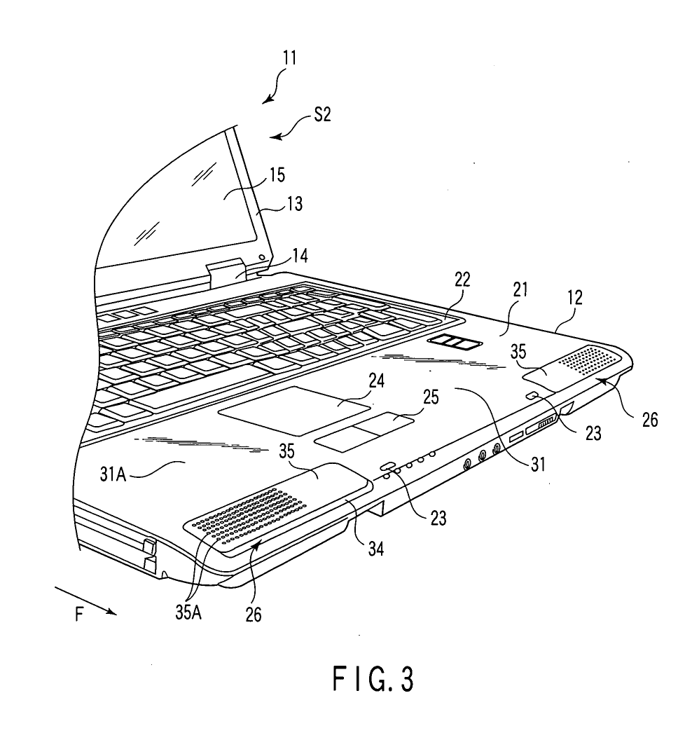

As shown in FIG. 3, the illumination devices 26 are arranged as front as the receiving portions 23, or more to the front of the receiving portions 23. Therefore, the illumination devices 26 are arranged in the vicinity of the receiving portions 23 in positions corresponding to the receiving portions 23. Specifically, the illumination devices 26 are arranged most toward the front in the front direction F in the main unit 12.

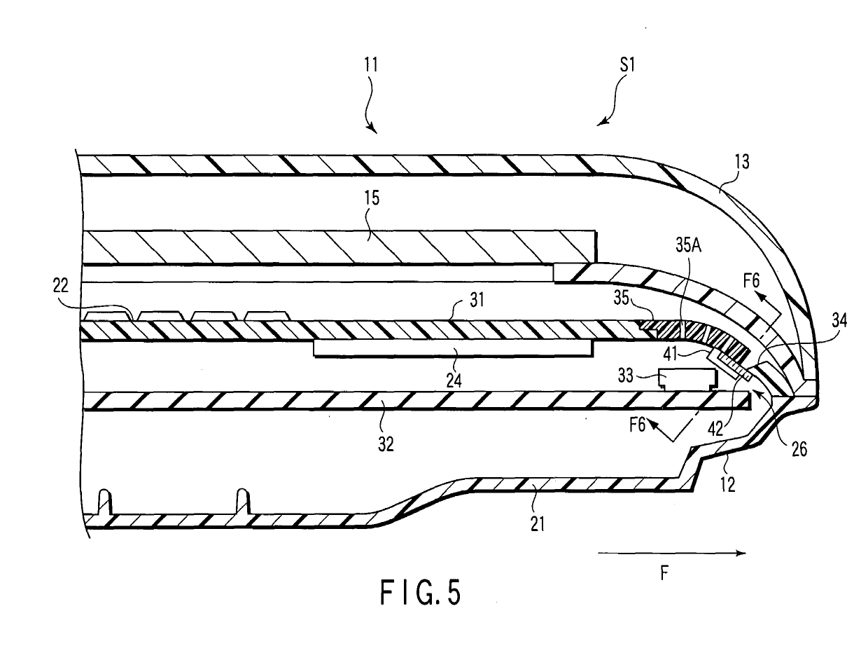

As shown in FIG. 5, the housing 21 contains a circuit board 32, speaker devices 33 mounted on the circuit board 32, and the illumination devices 26. The speaker devices 33 are disposed in the vicinity of the illumination devices 26.

As shown in FIG. 3, the main unit 12 has notch portions 34 cut away to correspond to the illumination devices 26 and the speaker devices 33, and covers 35 to be fit into the respective notch portions 34 and cover the illumination devices 26 and the speaker devices 33. Each cover 35 has a plurality of hole portions 35A that transmit sound of the speaker devices 33 to the outside. Bottom parts of the notch portions 34 are not covered with the covers 35. Therefore, the illumination devices 26 are exposed to the outside of the housing 21 in the bottom parts.

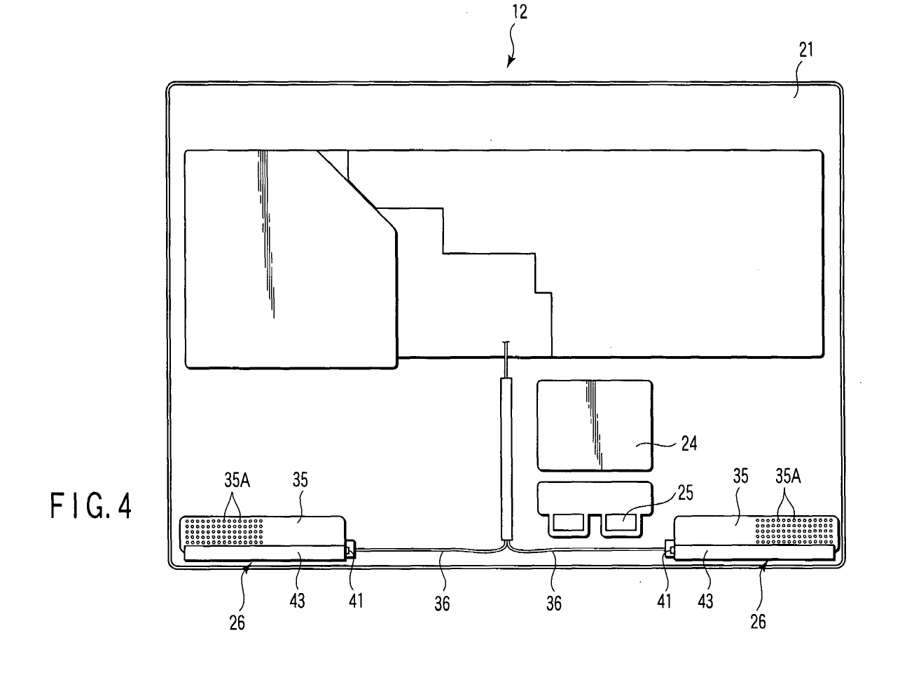

FIG. 4 is a bottom view of a part of the housing 21. As shown in FIG. 4, the illumination devices 26 are provided in the respective width end portions of the main unit 12 to form a pair. Each of the illumination devices 26 is connected to the circuit board 32 illustrated in FIG. 5 through wire 36. The illumination devices 26 are interlocked with the power source of the portable computer 11, to continuously emit light when the power is on.

As shown in FIGS. 4 to 6, each illumination device 26 has a light-emitting diode (LED) 41 serving as a light source, a lens 42, and a reflecting board 43 formed of resin and adhered to the lens 42. As the light-emitting diode 41, a diode which emits blue light is used, for example. The lens 42 is formed of translucent resin material. As shown in FIG. 5, the lens 42 is secured to the cover 35 and the housing 21. The lens 42 is disposed in an inclined state with respect to the extending direction of the keyboard 22, such that the lens 42 is gradually inclined downward toward the front direction F.

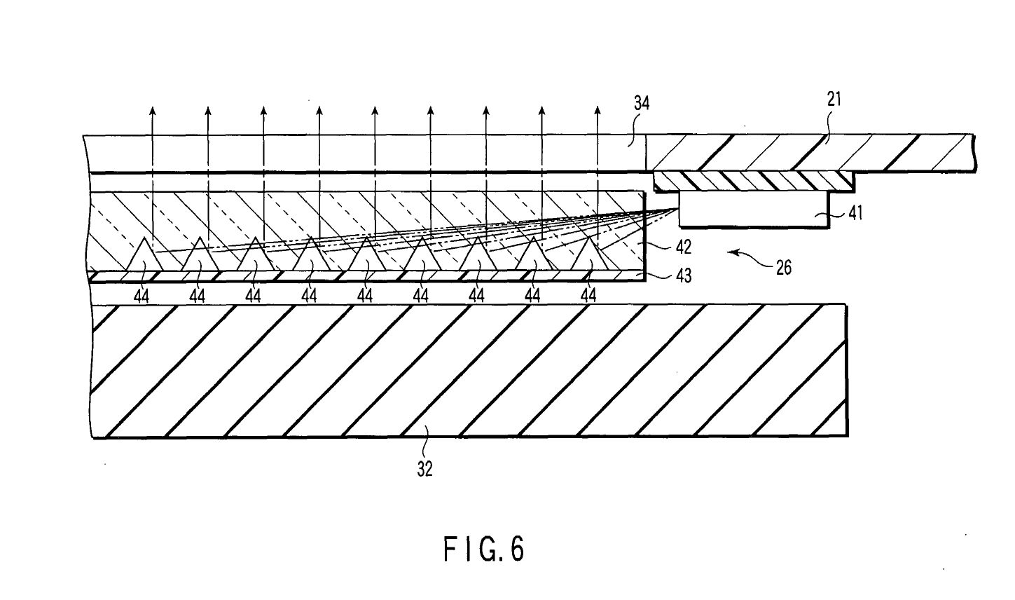

As shown in FIG. 6, the lens 42 is provided with a plurality of V-shaped groove portions 44. The groove portions 44 are arranged at regular intervals on the lens 42. When light is applied from the light-emitting diode 41 to the lens 42, the light is reflected by the groove portions 44, as indicated by chain double-dashed lines. Thereby, light is projected to the outside of the housing 21. The groove portions 44 are arranged on the lens 42 with uniform pitches. This enables the lens 42 to project uniform light to the outside.

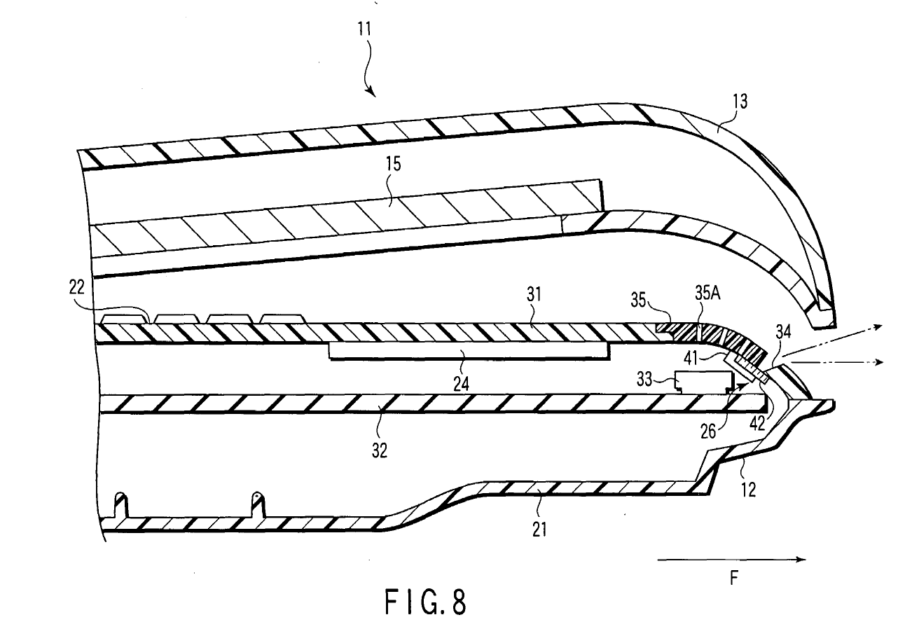

The light projected from the lens 42 is projected to the outside through the notches 34. Among the light projected from the lens 42, a part of the light projected upward is blocked by the covers 35, as shown in FIG. 8. Therefore, the light projection angle by the illumination devices 26 is limited to a direction parallel to the extending direction of the keyboard 22.

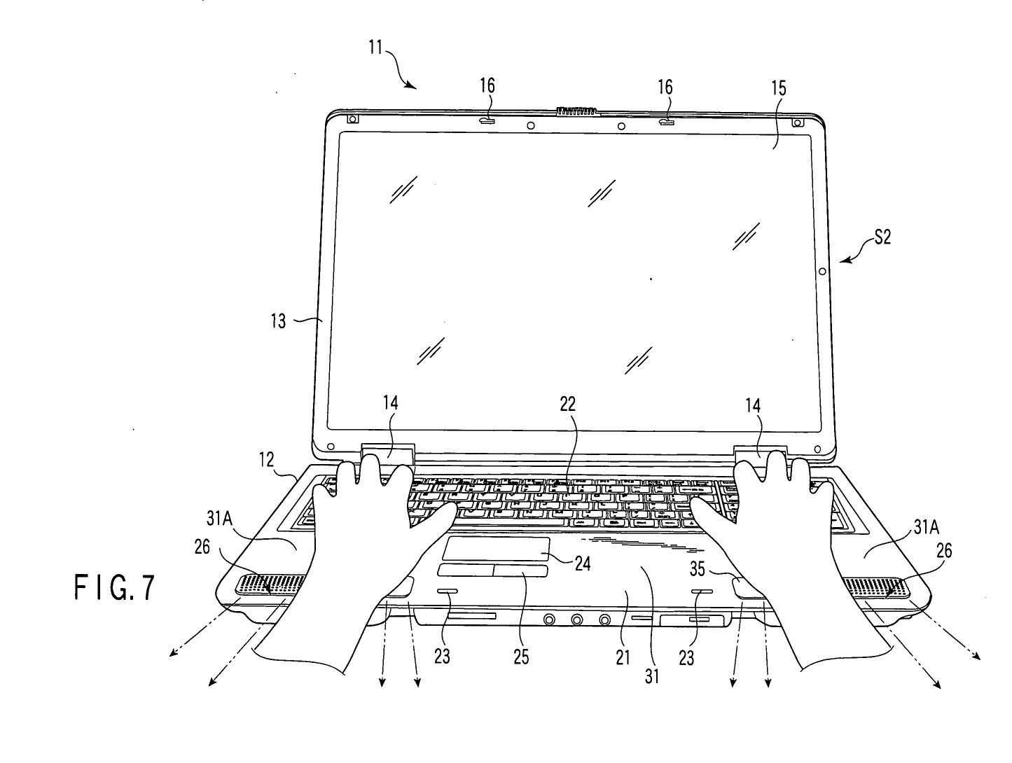

Next, operation of the portable computer 11 of the embodiment is explained. In use, the portable computer 11 is used with the display unit 13 in the second state S2, as shown in FIG. 2. When the power is turned on in this state, the electric power is supplied to the illumination devices 26, and the illumination devices 26 emit light. Further, as shown in FIG. 7, when the user rests one's hands on the palm rest portion 31 while using the portable computer 11 as shown in FIG. 7, a part of light from the illumination devices 26 is blocked by the user's hands. The other part of the light which is not blocked by the user's hands is projected as indicated by chain double-dashed lines, and illumination effect is produced.

For example, suppose that the user closes the display unit 13 with the power of the portable computer 11 in the on state, and suspends use of the portable computer 11, as shown in FIG. 5. In this case, when the user opens the display unit 13 and uses the portable computer 11 again, light is projected from the illumination devices 26 to the outside at the moment when the display unit 13 is opened as shown in FIG. 8. This structure enables the user to instantly recognize that the power is on. Further, light from the illumination devices 26 comes through the gap between the display unit 13 and the main unit 12, and thereby excellent visual effect is obtained. Further, when user fails to completely close the display unit 13 from the second state S2 to the first state S1, the light from the illumination devices 26 comes through the gap between the main unit 12 and the display unit 13. Therefore, the illumination devices 26 are also useful for user's recognition of insufficient closure of the display unit 13.

According to the above embodiment of the portable computer 11, the illumination devices 26 are provided in the area of the main unit 12, which is covered with the display unit 13 in the first state S1. Since the illumination devices 26 are arranged in positions which the user can view the devices while using the portable computer 11, it is possible to sufficiently produce the visual effect of the illumination devices 26. Further, even if the portable computer 11 is inadvertently bumped against the wall or the like while being moved with the display unit 13 in the first state S1, the above structure prevents the illumination devices 26 from being directly damaged.

Further, the illumination devices 26 are arranged opposite the display unit 13 in the second state S2, with the palm rest portion 31 interposed therebetween. In this structure, the illumination devices 26 are provided distant from the display unit 13. Providing the illumination devices 26 distant from the display unit 13 reduces the possibility that the light of the illumination devices 26 directly enters the user's eyes. This structure prevents deterioration in the viewability of the display 15 due to the illumination devices 26. Furthermore, the illumination devices 26 arranged in these positions produce their visual effects at the moment when the user opens the display unit 13 in the first state S1. Further, the user can use the illumination devices 26 as a guide when resting one's hands on the palm rest portion 31.

The illumination devices 26 have the width L2 larger than the width L1 of the regions 31A of the palm rest portion 31 on which the user's hands are placed. Therefore, even if the user's hands are rested on the palm rest portion 31, light is projected from parts of the illumination devices 26 in the positions which are not blocked by the user's hands. This structure avoids prevention of the effect of the illumination devices 26 by the user's hands.

The illumination devices 26 are provided in positions corresponding to the receiving portions 23. Therefore, the illumination devices 26 are arranged closest to the front in the front direction F. This structure enables the illumination devices 26 to produce sufficient visual effect at the moment when the user opens the display unit 13 in the first state S1.

The illumination devices 26 being a pair are provided in width end portions of the main unit 12. This structure enables the user to recognize the width of the portable computer 11 by intuition. Further, the illumination devices 26 can be formed in one unitary piece with other pair structural elements such as the speaker devices 33.

Further, the covers 35 have the hole portions 35A to transmit sound of the speaker devices 33 to the outside. Therefore, the covers 35 are also used as the covers of the speaker devices 33, and the use efficiency of the space is improved. Furthermore, the illumination devices 26 are formed in one unitary piece with the speaker devices 33, and thereby the appearance of the portable computer 11 is improved.

In the light projected from the illumination devices 26, the covers 35 block part of the light which is projected upward. This prevents the light from the illumination devices 26 from being directly projected to the user's eyes. This structure prevents deterioration in the viewability of the display 15.

The lens 42 of the illumination devices 26 is provided in an inclined state with respect to the palm rest portion 31. This structure prevents projection of the light of the illumination devices 26 toward the user's eyes, even if the illumination devices 26 are provided in the area 27 covered with the display unit 13. In particular, according to the structure where the lens 42 is disposed in an inclined state such that the lens is gradually inclined downward in the front direction F as in the embodiment, the light of the illumination devices 26 is effectively projected from the gap between the main unit 12 and the display unit 13 when the display unit 13 in the first state S1 is opened.

Each of the illumination devices 26 has the reflecting board 43. This improves the reflection efficiency of light applied from the light source. Further, the light-emitting diode 41 used as the light source produces a more beautiful visual effect.

The information processing apparatus of the present invention is not limited to the portable computer explained in the above embodiment, but may be other information processing apparatuses such as mobile information terminals. Further, although the display unit 13 in the embodiment does not rotate in the axial direction of the hinge parts 14, the present invention is also applicable to tablet type portable computers which rotate around the axes of the hinge parts.

The illumination devices 26 can be variously modified and carried out as follows, within the range not departing from the gist of the invention. Specifically, although the illumination devices 26 in the above embodiment have the structure in which the light-emitting diode 41 is provided on one side of the lens 42, light-emitting diodes 41 may be provided on both sides of the lens 42. This modification increases the intensity of the light. Further, for example, it is possible to use light-emitting diodes 41 of two colors, such as a blue light diode and an orange light diode, to alternately generate light beams of the two colors, or mix light beams of the two colors.

Further, although the groove portion 44 of the lens 42 are formed at regular pitches in the above embodiment, desired pitches may be adopted as the pitches of the groove portions 44. This enables providing variations in intensity of the light projected from the lens 42. Furthermore, although the illumination devices 26 are provided toward the front of the main unit 12 in the front direction F in the above embodiment, the illumination devices 26 may be provided in any position within the area 27 on the main unit 12, which is covered with the display unit 13 in the first state S1. For example, the illumination devices 26 may be provided on left and right sides of the keyboard 22, or between the keyboard 22 and the hinge parts 14. If the illumination devices 26 are provided in the vicinity of the display unit 13, the angle of the lens 42 is preferably changed as in the above embodiment, to prevent the illumination devices 26 from deteriorating the viewability of the display 15.

It is also possible to provide the illumination devices 26 in positions other than the area 27 on the main unit 12. In such a case, it is preferable to consider the shock resistance, for example, to provide the illumination devices 26 inside the housing 21.

The illumination devices 26 may be operated in synchronization with the sound volume of the speaker devices 33, to increase and decrease the light intensity. In this case, more specifically, either of two methods may be adopted, that is, a method of uniformly increasing the light of the illumination devices 26 in proportion to the sound volume, and a method of increasing and decreasing the light in synchronization with the current sound volume. These methods improve the visual effect of the illumination devices 26.

Further, a special lens may be used, in which an enclosed space may be provided inside the lens and liquid or gel is injected into the space. This structure makes the reflection pattern of the lens irregular, and broadens the expression by the illumination.

In this case, a luminous material may be used as the liquid or gel to be injected into the space. The illumination devices using a luminous material emit light in darkness even after the power is turned off, and a further visual effect is obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main unit having a palm rest portion;
a display unit being rotatable between a first state, in which the display unit is closed with respect to the main unit, and a second state in which the display unit is opened with respect to the main unit; and
an illumination device which is disposed opposite the display unit in the second state, with the palm rest portion interposed therebetween.

2. An information processing apparatus according to claim 1, further comprising another illumination device, wherein
the illumination devices are provided in respective width end portions of the main unit to form a pair.

3. An information processing apparatus according to claim 1, wherein
the illumination device has a width larger than a width of an area of the palm rest portion, on which a user's hand is placed.

4. An information processing apparatus according to claim 1, wherein
the display unit has a latch,
the main unit has a receiving portion with which the latch is engaged, and
the illumination device is provided in a position corresponding to the receiving portion.

5. An information processing apparatus according to claim 1, wherein
the main unit has a housing and a speaker device which is located in the vicinity of the illumination device,
the housing includes a cover which covers the illumination device and the speaker device, and
the cover has a hole portion to transmit sound of the speaker device to the outside.

6. An information processing apparatus according to claim 1, wherein
the main unit has a housing,
the housing includes a cover which covers the illumination device, and
the cover blocks light which is projected upward from the illumination device.

7. An information processing apparatus according to claim 1, wherein
the illumination device includes a light source and a lens which projects light of the light source to surroundings, and
the lens is disposed in an inclined state with respect to the palm rest portion.

8. An information processing apparatus according to claim 7, wherein
the illumination device includes a reflecting board.

9. An information processing apparatus according to claim 1, wherein
the illumination device is provided in an area on the main unit, which is covered with the display unit in the first state.
